(19) United States
(12) Patent Application Publication
(10) Pub. No.: US 2014/0145451 A1
(43) Pub. Date: May 29, 2014

(54) Counterweight powered gravity electrical generation

(71) Applicant: Bruce W. Burnaugh, Springfield, MO (US)

(72) Inventor: Bruce W. Burnaugh, Springfield, MO (US)

(21) Appl. No.: 13/459,202

(22) Filed: Apr. 29, 2012

(51) Int. Cl. H02K 99/00

(52) U.S. Cl. CPC H02K 57/003
USPC 290/1 R

(57) ABSTRACT

The production of electrical energy produced by the gravitational pull of the Earth of a counter weight, which will in turn lift a drive weight so that it can be released to the gravitational pull to mechanically turn a generator connected by gears. This is also distinct from gravitational equipment using only a flywheel system instead of flywheel, and moving counter weights on rails.

### INCORPORATION BY REFERENCE

File contains cover letter, specification, abstract, claims and numerical reference sheet. Compact discs are identical—file name Counterweight Powered Gravity Electrical Generation—file size 179 kB—date of file Jun. 3, 2013.

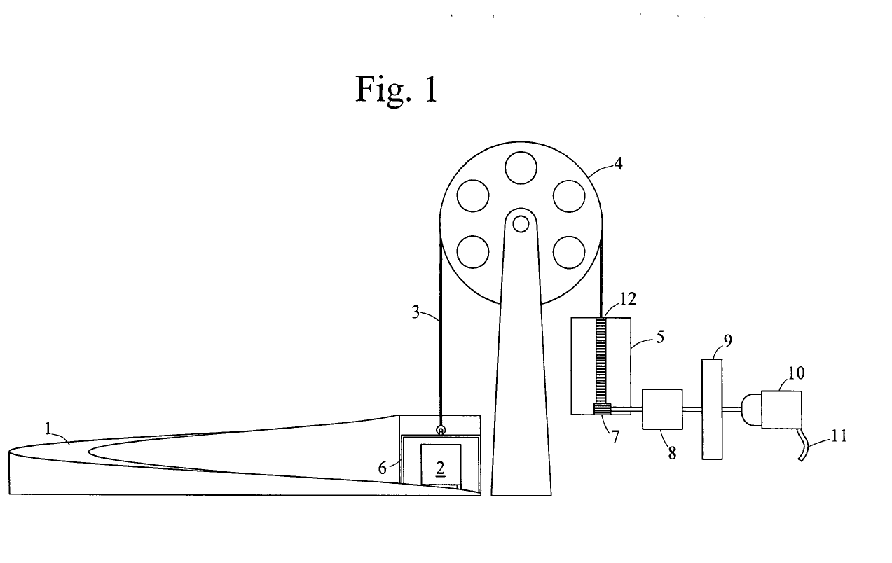

FIG. 1 shows a front view of the drive weight (5) drawn up by the counterweight, (2) which is a heavy electric rail car in an elevator (6). The railcar (2) drives up the ramp (1) to the top where it will enter the elevator (6) when pulled up by the falling of the drive weight (5) attached by a cable (3) over a pulley wheel (4). Electricity is produced by the falling of the drive weight, (5) which has a rack or series of racks (12) which rotate a pinion wheel (7) which is connected to the electrical generator (10) sending electricity through the output cable (11). To help facilitate production there is a gearbox (8) which will change the rpm of the pinion wheel (7) to a more suitable speed for the generator (10). Finally, a flywheel (9) maintains inertia. This cycle continues to repeat.

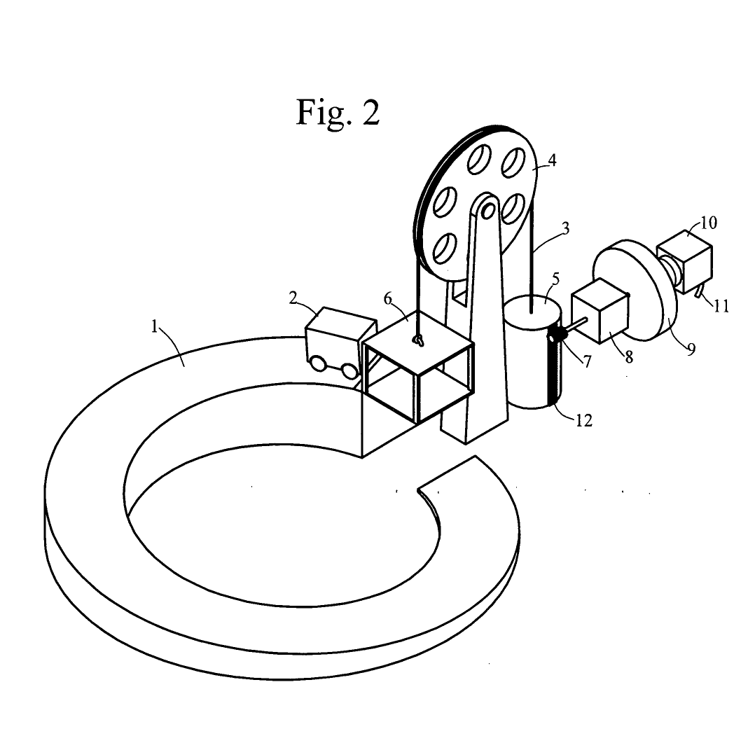

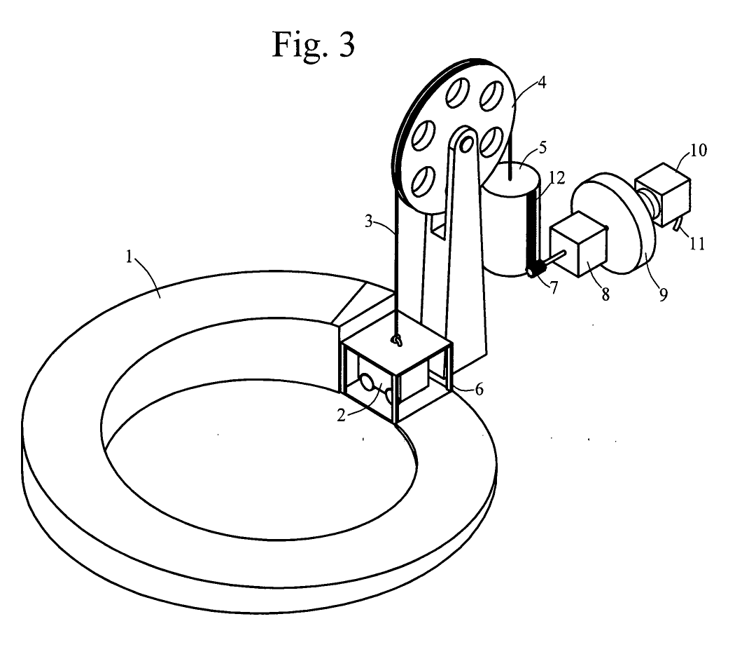

FIG. 2 shows an isometric view of the process with the electric railcar (2) at the top entering the elevator (6) and the drive weight (5) having turned the pinion wheel (7). Inertia is maintained by the flywheel, (9) while the pinion disengages and the railcar (2) enters the elevator (6).

### NUMERICAL REFERENCE LIST

1. Ramp for electric driven counterweight railcars

2. Railcar counterweight

3. Cable connecting drive weight to counterweight

4. Pulley wheel supporting drive and counterweights

5. Drive weight

6. Counterweight elevator carriage

7. Pinion wheel

8. Gear reduction box

9. Flywheel

10. Electrical generator

11. Electrical power cord

12. Rack

1. Electrical generation using counterweight to raise drive weight

2. Electrical generation using large flywheels to sustain kinetic motion

3. Counterweight is not connected to drive shaft

4. Counterweight is electric powered rail car

5. Drive weight is attached to counterweight

6. Drive weight turns gear on drive shaft

7. Rail car drives up track from bottom of weight fall to top of weight fall
